(19) United States
(12) Patent Application Publication
(10) Pub. No.: US 2022/0111708 A1
(43) Pub. Date: Apr. 14, 2022

(54) CONVERTIBLE VEHICLE DOORS

(71) Applicant: Clifford Krapfl, Chicago, IL (US)

(72) Inventor: Clifford Krapfl, Chicago, IL (US)

(21) Appl. No.: 17/068,960

(22) Filed: Oct. 13, 2020

(51) Int. Cl. B60J 5/04; B60R 16/03; E05F 15/00; B60R 1/078

(52) U.S. Cl. CPC B60J 5/0463; B60J 5/0413; B60J 5/0469; B60J 5/0487; B60R 16/03; E05Y 2400/10; B60J 5/0402; B60R 1/078; B60J 5/0455; E05Y 2900/531; E05F 15/00

(57) ABSTRACT

A convertible vehicle door includes a high visibility off-road frame door including a hinge assembly to hingedly couple to a vehicle body, and an exterior on-road panel configured to hingedly couple to the hinge assembly outboard of the high visibility off-road frame door. The convertible vehicle door is convertible between an on-road door configuration where the exterior on-road panel is coupled to the high visibility off-road frame door, and an off-road door configuration where the exterior on-road panel is detached from the high visibility off-road frame door.

### FIELD

The present application relates generally to vehicle door systems and, more particularly, to removable door systems convertible between on-road and off-road driving configurations.

### BACKGROUND

It is known in the motor vehicle art to provide a convertible top, which may be folded back or removed from the vehicle to provide a user the benefit of open air driving while affording available protection in the event of adverse weather conditions. Such vehicles typically include a set of highway use doors. In order to further improve open air driving and provide increased off-road visibility, some users also acquire a second set of specially designed off-road doors. However, switching between the two sets of doors can potentially be complex and time consuming. Therefore, while such systems work well for their intended purpose, it is desirable to provide continuous improvement in the relevant art.

### SUMMARY

In accordance with one example aspect of the invention, a convertible vehicle door is provided. In one example implementation, the convertible vehicle door includes a high visibility off-road frame door including a hinge assembly to hingedly couple to a vehicle body, and an exterior on-road panel configured to hingedly couple to the hinge assembly outboard of the high visibility off-road frame door. The convertible vehicle door is convertible between an on-road door configuration where the exterior on-road panel is coupled to the high visibility off-road frame door, and an off-road door configuration where the exterior on-road panel is detached from the high visibility off-road frame door.

In addition to the foregoing, the described convertible vehicle door may include one or more of the following features: an interior door panel configured to be removably coupled to the high visibility off-road frame door inboard thereof, wherein in the on-road door configuration, the interior door panel is coupled to the high visibility off-road frame door, and wherein in the off-road configuration, the interior door panel is detached from the high visibility off-road frame door; electronics housed within the interior door panel; and wherein the electronics include a power window control system and a power side view mirror control system.

In addition to the foregoing, the described convertible vehicle door may include one or more of the following features: wherein the high visibility off-road frame door is a tubular frame; wherein the tubular frame has a rectangular or elliptical cross-section; wherein the tubular frame is a perimeter frame outlining the exterior on-road panel and defining a window therein to enable visibility through the perimeter frame; a transferrable side view mirror configured to be coupled to the exterior on-road panel in the on-road door configuration, and coupled to the high visibility off-road frame door in the off-road door configuration; and wherein the transferrable side mirror is configured to couple to a mirror support flange of the high visibility off-road frame door.

In addition to the foregoing, the described convertible vehicle door may include one or more of the following features: a transferrable door handle configured to be coupled to the exterior on-road panel in the on-road door configuration, and coupled to the high visibility off-road frame door in the off-road door configuration; wherein hinge assembly comprises a leaf having a first knuckle hingedly coupled to a second knuckle by an off-road door pin, wherein the leaf is configured to couple to the vehicle body, and wherein the second knuckle is coupled to the high visibility off-road frame door; wherein the exterior on-road panel includes a third knuckle with an on-road door pin extending therefrom, wherein the on-road door pin is received within the second knuckle to facilitate further coupling of the exterior on-road panel to the high visibility off-road frame door; wherein the exterior on-road panel comprises a door structure, a window frame, and a window; and wherein the exterior on-road panel houses a window lift mechanism configured to raise and lower the window.

In accordance with another example aspect of the invention, a vehicle is provided. In one example implementation, the vehicle includes a body, and a driver door and a passenger door at least partially defining a passenger compartment. The driver door and the passenger door are each convertible vehicle doors including a high visibility off-road frame door including a hinge assembly to hingedly couple to the vehicle body, and an exterior on-road panel configured to hingedly couple to the hinge assembly outboard of the high visibility off-road frame door. The convertible vehicle door is convertible between an on-road door configuration where the exterior on-road panel is coupled to the high visibility off-road frame door, and an off-road door configuration where the exterior on-road panel is detached from the high visibility off-road frame door.

In addition to the foregoing, the described vehicle may include one or more of the following features: wherein the convertible vehicle doors further comprise an interior door panel configured to be removably coupled to the high visibility off-road frame door inboard thereof, wherein in the on-road door configuration, the interior door panel is coupled to the high visibility off-road frame door, and wherein in the off-road configuration, the interior door panel is detached from the high visibility off-road frame door; wherein the convertible vehicle doors further include a transferrable side view mirror configured to be coupled to the exterior on-road panel in the on-road door configuration, and coupled to the high visibility off-road frame door in the off-road door configuration, and a transferrable door handle configured to be coupled to the exterior on-road panel in the on-road door configuration, and coupled to the high visibility off-road frame door in the off-road door configuration.

In addition to the foregoing, the described vehicle may include one or more of the following features: a pair of rear convertible vehicle doors each including a rear high visibility off-road frame door including a rear hinge assembly to hingedly couple to the vehicle body, a rear exterior on-road panel configured to hingedly couple to the rear hinge assembly outboard of the rear high visibility off-road frame door, wherein the rear convertible vehicle door is convertible between a rear on-road door configuration where the rear exterior on-road panel is coupled to the rear high visibility off-road frame door, and a rear off-road door configuration where the rear exterior on-road panel is detached from the rear high visibility off-road frame door.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings references therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a side view of an example vehicle with convertible doors in an on-road configuration, in accordance with the principles of the present application;

FIG. 2 is an exploded view of another example convertible vehicle door, in accordance with the principles of the present application; and

FIG. 3 is a perspective view of the convertible vehicle door shown in FIG. 2 in an on-road configuration, in accordance with the principles of the present application.

### DESCRIPTION

According to the principles of the present application, systems and methods are described for convertible vehicle doors configured to convert between an on-road door configuration and an off-road door configuration. In example embodiments, the convertible vehicle doors include a high visibility tubular framed off-road door disposed between an interior door panel and an exterior on-road panel. When the on-road door configuration is desired, the interior door panel and exterior on-road panel are attached to the off-road door. When the off-road configuration is desired, the interior door panel and exterior on-road panel are detached from the off-road door. In addition, the convertible doors can include transferrable side view mirrors and handle assemblies that are removable from the exterior on-road panel for subsequent reattachment to the off-road door.

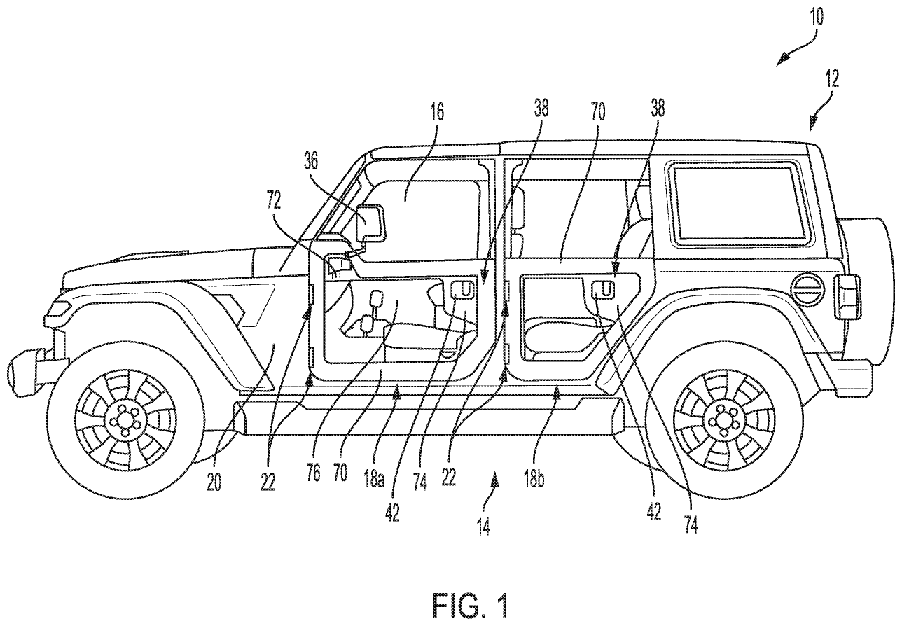

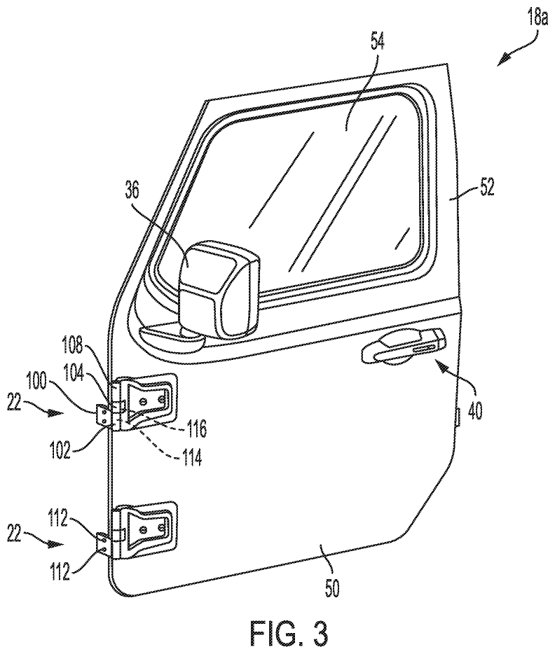

With initial reference to FIG. 1, a vehicle 10 having a convertible top system 12 and a convertible door system 14 in accordance with the principles of the present disclosure is illustrated. As shown, the convertible top system 12 and the convertible door system 14 at least partially enclose and define a passenger compartment 16 in which the vehicle driver and passengers sit during operation of the vehicle. In the example embodiment, the convertible top system 12 is a hard top system, however, it will be appreciated that convertible top system 12 may be a soft top or other system. In the example implementation, the convertible door system 14 includes selectively removable, convertible doors 18 removably coupled to a body 20 of the vehicle by one or more door hinge assemblies 22. As described herein in more detail, each convertible door 18 is transformable between an off-road configuration (FIG. 1) and an on-road configuration (FIG. 3). Further, each convertible door 18 is removably coupled to the body 20 to enable users to remove the doors entirely from the vehicle 10.

With reference now to FIGS. 1-3, the transformable doors 18 will be described in more detail. As shown in FIG. 1, vehicle 10 includes a pair of removable front doors 18a and a pair of removable rear doors 18b. It will be appreciated, however, that vehicle 10 can have any suitable number of doors, some or all of which are transformable between the on-road configuration and the off-road configuration. Further, for ease of discussion, only the front driver side door will be described in detail, but it will be appreciated that any or all of convertible doors 18 can be structurally and functionally identical or substantially similar thereto.

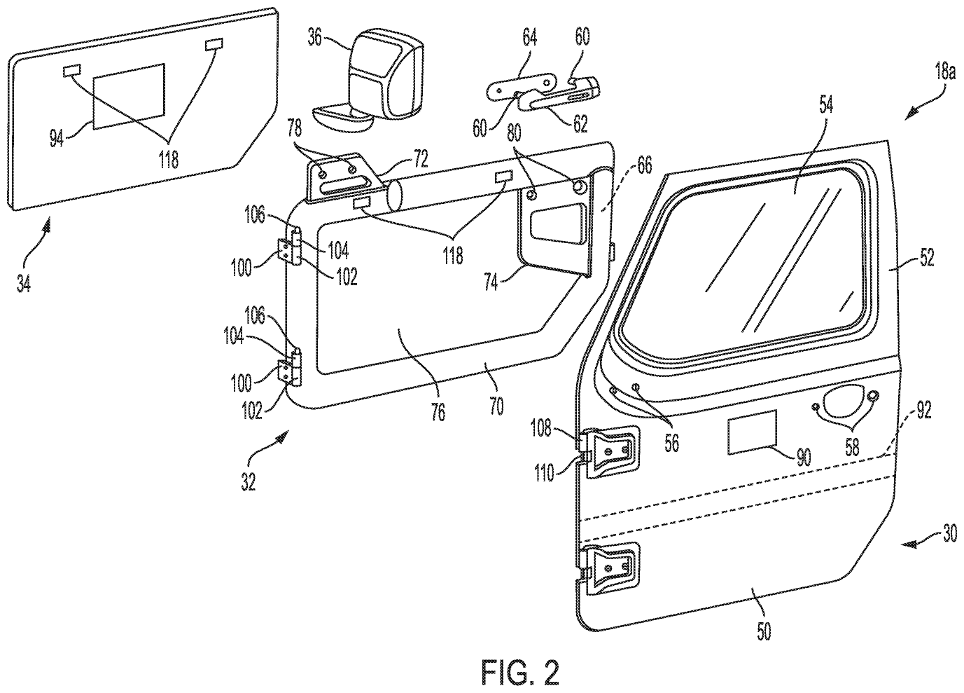

As shown in FIG. 2, in the example embodiment, convertible front door 18a generally includes an exterior on-road panel 30, a high visibility off-road frame door 32, and an interior door panel 34. Advantageously, the exterior on-road panel 30 and the interior door panel 34 are removably coupled to the off-road door 32 to convert into the off-road configuration. In the on-road configuration of door 18a, the off-road door 32 is disposed or “sandwiched” between the exterior on-road panel 30 and the interior door panel 34 such that the off-road door 32 is concealed therebetween (FIG. 3). The exterior on-road panel 30 and the interior door panel 34 can be subsequently uncoupled from the off-road door 32, thereby providing an open air, off-road door configuration for the vehicle 10, as shown in FIG. 1.

In the example implementation shown in FIG. 2, the exterior on-road panel 30 includes side windows 54, associated window lift mechanisms/motor 90, and cross-member door supports 92, while the interior door panel 34 houses the vehicle door electronics 94 (shown schematically) such as, for example, power lock controls, window controls, power side view mirror controls, lighting, and the like. Additionally, in the example implementation, front doors 18a include a transferable side view mirror 36, while the doors 18 have either a first door handle configuration 38 (FIG. 1) or a transferable second door handle configuration 40 (FIGS. 2 and 3).

In the example embodiments, the exterior on-road panel 30 generally includes a door structure 50 (e.g., door sheet metal), a window frame 52, a window 54, and a portion of hinge assembly 22. The door structure 50 includes one or more apertures 56 configured to receive fasteners (not shown) for coupling the side view mirror 36 to the exterior on-road panel 30. However, it will be appreciated that side view mirror 36 may be coupled to the exterior on-road panel 30 by an suitable means that enables door 18a to function as described herein.

When utilizing the first door handle configuration 38 (FIG. 1), the door structure 50 may include an aperture (not shown) that enables a user to access the off-road door handle 42 when the exterior on-road panel 30 is coupled to the off-road door 32. Alternatively, the exterior on-road panel 30 may include an exterior door handle (not shown) that is operably coupled to the off-road door handle 42 when exterior on-road panel 30 is secured to the off-road door 32.

When utilizing the second door handle configuration 40 (FIGS. 2 and 3), the door structure 50 includes one or more apertures 58 configured to receive one or more posts 60 of a transferrable door handle 62 (FIG. 2), which can be coupled to either or both of the exterior on-road panel 30 and off-road door 32. The post(s) 60 are configured to be inserted through the aperture(s) 58 to be secured to a plate 64 and operably coupled to a latching system 66 such as, for example a conventional door latch system and striker.

In the example embodiments, the off-road door 32 generally includes a tubular frame 70, a mirror support flange 72, a door handle support flange 74, and another portion of hinge assembly 22. In the illustrated example, the tubular frame 70 is a perimeter frame is configured to “outline” the exterior on-road panel 30 (below door structure 50 below the window frame 52) to visually integrate the components. In this way, the tubular frame 70 defines a space or window 76 therein, thus resulting in improved visibility and airflow therethrough, for example, during off-road driving. Further, in the example embodiments, tubular frame 70 has a generally rectangular cross-section or elliptical cross-section, for example, to reduce width of the tubular frame 70 and stack up of parts. However, frame 70 can be non-tubular and can have any suitable cross-section that enables off-road door 32 to function as described herein.

As shown in FIG. 2, the mirror support flange 72 includes one or more apertures 78 (two shown) configured to selectively align with apertures 56 to receive fasteners (not shown) for coupling the side view mirror 36 to the off-road door 32, as well as receive electrical connections for electrical systems of the side view mirror 36. In this way, side view mirror 36 can be coupled to either or both of the exterior on-road panel 30 and the off-road door 32. However, it will be appreciated that side view mirror 36 may be coupled to the off-road door 32 by an suitable means that enables door 18a to function as described herein.

When utilizing the first door handle configuration 38 (FIG. 1), the door handle support flange 74 supports and at least partially houses the off-road door handle 42 and the associated latch system 66. When utilizing the second door handle configuration 40 (FIGS. 2 and 3), the door handle support flange 74 includes one or more apertures 80 configured to selectively align with apertures 58 to receive posts 60 of the transferrable door handle 62. Once attached the transferable door handle 42 is configured to operably couple to the latch system 66, including a release mechanism. As noted herein, transferrable door handle 62 can be coupled to either or both of the exterior on-road panel 30 and the off-road door 32. Alternatively, the off-road door 32 can include a pull strap (not shown) supported by the tubular frame 70 and/or door handle support flange 74 to operate with the associated latch system 66, thereby enabling the door handle 62 to remain with the exterior on-road panel 30 after removal.

As shown in FIG. 2, in the example implementation, the interior door panel 34 is an interior trim panel configured as an interior covering for the vehicle door 18. The interior door panel 34 may be designed for aesthetics and to house/provide various features such as, but not limited to, armrests, handles, system control buttons, lights, speakers, and safety features like airbags. The interior door panel 34 is configured to be removably secured to the off-road door 32, for example, via fasteners, latches, hooks, or the like. In this way, the exterior on-road panel 30 and interior door panel 34 are selectively detached to convert the door 18 into only the off-road door 32.

Turning now to FIGS. 2 and 3, the door hinge assemblies 22 will be described in more detail. In the example embodiment, the door hinge assemblies 22 allow the convertible doors 18 to pivot between a closed position and an open position to allow a user of the vehicle 10 to enter and exit the passenger compartment 16. Further, the door hinge assemblies 22 are configured to enable a user to quickly and easily remove one or more portions of the convertible door 18 from the body 20 of the vehicle 10 using only simple tools such as a wrench, screwdriver, hex key, or other tool that may be conveniently stored within the vehicle 10. In this way, the user may remove the exterior on-road panel 30 from the off-road door 32, or remove entirely one or more doors 18 from the body 20 of the vehicle 10.

As shown in FIGS. 2 and 3, in the example implementation, each hinge assembly 22 is comprised of a leaf 100 having a first knuckle 102, a second or off-road door knuckle 104, a first or off-road door pin 106, and a third or on-road door knuckle 108 having a second or on-road door pin 110. The leaf 100 includes a plurality of apertures 112 configured to receive fasteners (not shown) for coupling the leaf 100 to the vehicle body 20. Alternatively, leaf 100 may be attached to body 20 by any suitable means such as, for example, via welding. The first knuckle 102 is coupled to or integrally formed with the leaf 100 and is a tubular, substantially cylindrical member defining a receiving aperture 114 (FIG. 3) extending therethrough.

The second knuckle 104 is coupled to or integrally formed with the off-road door 32 and is also a tubular, substantially cylindrical member defining a receiving aperture 116 extending therethrough. As shown in FIG. 2, the first and second knuckles 102, 104 are configured to be aligned such that the off-road door pin 106 can be inserted through receiving apertures 114, 116. A retaining member (e.g., a nut, not shown) may then be coupled to a bottom end of the off-road door pin 106 to hingedly secure the off-road door 32 to the vehicle body 20.

As shown in FIG. 2, in the example embodiment, the third knuckle 108 is a substantially cylindrical member coupled to or integrally formed with the on-road panel 30. The on-road door pin 110 is coupled to or integrally formed with the third knuckle 108 and extends downwardly therefrom. As shown in FIG. 3, the third knuckle 108 is configured to be aligned with the first and second knuckles 102, 104 such that the on-road door pin 110 can be inserted into receiving aperture 116. The exterior on-road panel 30 is subsequently secured to the off-road door 32 via attachments 118 (shown schematically) such as, for example, fasteners, latches, hooks, or the like to facilitate preventing the two from swinging apart during travel. In this way, the exterior on-road panel 30 and off-road door 32 are hingedly coupled to the vehicle body 20 as a unitary component. The convertible door 18 can then be quickly converted to only the off-road door 32 by simply de-coupling the exterior on-road panel 30 from the off-road door 32 and lifting to remove the on-road door pin 110 from the receiving aperture 116.

In one example operation, the convertible door 18a begins in the on-road configuration shown in FIG. 3. In order to convert door 18a to the off-road configuration, the interior door panel 34 is detached from the off-road door 32, and side view mirror 36 is removed from the exterior on-road panel 30. If utilizing the second door handle configuration 40, the door handle 62 is also removed from the exterior on-road panel 30. The exterior on-road panel 30 is then detached from the off-road door 32 and separated from the hinge assembly 22 by pulling the on-road door pin 110 upward and out of the second knuckle 104. The door handle 62 is then reattached to the off-road door 32, unless utilizing the first door handle configuration 38. Similarly, the side view mirror 36 is reattached to the off-road door 32, or a second non-electronic side view mirror (not shown) could be attached to the off-road door 32. The convertible door 18a is then in the off-road configuration. The steps can then be reversed to convert the door 18a back into the on-road configuration.

Described herein are systems and methods for a convertible vehicle door configured to be converted between an on-road configuration and an off-road configuration. The system includes a tubular off-road door disposed inboard of an exterior on-road panel and outboard of an interior door panel, each of which are selectively detachable from the off-road door. When the on-road configuration is desired, the exterior on-road panel and the interior door panel are reattached to the off-road door to form a single unit hingedly coupled to the vehicle body. When the off-road configuration is desired, the exterior on-road panel and the interior door panel are detached, leaving only the off-road door coupled to the vehicle body. The tubular off-road doors provide better visibility when off-roading and are advantageously integrated into the vehicle's design, thereby obviating the need for a separate set of off-roading doors. As such, the transformable doors allow for user selection between on-road and off-road configurations, which reduces complexity and changing time associated with separate on-road and off-road vehicle doors.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present disclosure, its application or uses. Thus, variations that do not depart from the gist of the present disclosure are intended to be within the scope of the present disclosure.

1. A convertible vehicle door comprising:
an off-road open frame door including a hinge assembly to hingedly couple to a vehicle body; and
an exterior on-road panel configured to hingedly couple to and become part of the hinge assembly, the exterior on-road panel being outboard of the off-road open frame door,
an interior door panel configured to be removably coupled to the off-road open frame door inboard thereof,
wherein the convertible vehicle door is convertible between an on-road door configuration where the exterior on-road panel is coupled to the off-road open frame door, and an off-road door configuration where the exterior on-road panel is detached from the off-road open frame door,
wherein in the on-road door configuration, the interior door panel is coupled to the off-road open frame door and wherein in the off-road configuration, the interior door panel is detached from the off-road open frame door,
wherein the off-road open frame door is a continuous tubular member defining a perimeter shaped like a perimeter of a door structure of the exterior on-road panel.

2. The convertible vehicle door of claim 1, further comprising electronics housed within the interior door panel.

3. The convertible vehicle door of claim 2, wherein the electronics include a power window control system and a power side view mirror control system.

4. (canceled)

5. The convertible vehicle door of claim 1, wherein the tubular member is a frame having a rectangular or elliptical cross-section.

6. The convertible vehicle door of claim 1, wherein the entire perimeter of the tubular member defines an uninterrupted window therein to enable visibility through the perimeter of the tubular member.

7. The convertible vehicle door of claim 1, further comprising a transferrable side view mirror configured to be coupled to the exterior on-road panel in the on-road door configuration, and coupled to the off-road open frame door in the off-road door configuration.

8. The convertible vehicle door of claim 7, wherein the transferrable side mirror is configured to couple to a mirror support flange of the off-road open frame door.

9. The convertible vehicle door of claim 1, further comprising a transferrable door handle configured to be coupled to the exterior on-road panel in the on-road door configuration, and coupled to the off-road open frame door in the off-road door configuration.

10. The convertible vehicle door of claim 1, wherein hinge assembly comprises a leaf having a first knuckle hingedly coupled to a second knuckle by an off-road door pin,
wherein the leaf is configured to couple to the vehicle body, and
wherein the second knuckle is coupled to the off-road open frame door.

11. The convertible vehicle door of claim 10, wherein the exterior on-road panel includes a third knuckle with an on-road door pin extending therefrom, wherein the on-road door pin is received within the second knuckle to facilitate further coupling of the exterior on-road panel to the off-road open frame door.

12. The convertible vehicle door of claim 1, wherein the exterior on-road panel comprises the door structure, a window frame, and a window.

13. The convertible vehicle door of claim 12, wherein the exterior on-road panel houses a window lift mechanism configured to raise and lower the window.

14. A vehicle comprising:
a body;
a driver door and a passenger door at least partially defining a passenger compartment; and
a pair of hinge assemblies hingedly coupling the respective driver and passenger doors to the body, wherein a first portion of the hinge assembly is coupled to the body,
wherein the driver door and the passenger door are each convertible vehicle doors comprising:
an off-road open frame door including a second portion of the hinge assembly configured to hingedly couple to the first portion of the hinge assembly; and
an exterior on-road panel having a third portion of the hinge assembly configured to hingedly couple to the second portion of the hinge assembly outboard of the off-road open frame door,
wherein the convertible vehicle door is convertible between an on-road door configuration where the exterior on-road panel is coupled to the off-road open frame door, and an off-road door configuration where the exterior on-road panel is detached from the off-road open frame door.

15. The vehicle of claim 14, wherein the convertible vehicle doors further comprise an interior door panel configured to be removably coupled to the off-road open frame door inboard thereof,
wherein in the on-road door configuration, the interior door panel is coupled to the off-road open frame door, and
wherein in the off-road configuration, the interior door panel is detached from the off-road open frame door.

16. The vehicle of claim 14, wherein the convertible vehicle doors further comprise:
a transferrable side view mirror configured to be coupled to the exterior on-road panel in the on-road door configuration, and coupled to the off-road open frame door in the off-road door configuration; and
a transferrable door handle configured to be coupled to the exterior on-road panel in the on-road door configuration, and coupled to the off-road open frame door in the off-road door configuration.

17. The vehicle of claim 14, further comprising a pair of rear convertible vehicle doors each comprising:
a rear off-road open frame door including a rear hinge assembly to hingedly couple to the vehicle body; and
a rear exterior on-road panel configured to hingedly couple to the rear hinge assembly outboard of the rear off-road open frame door,
wherein the rear convertible vehicle door is convertible between a rear on-road door configuration where the rear exterior on-road panel is coupled to the rear off-road open frame door, and a rear off-road door configuration where the rear exterior on-road panel is detached from the rear off-road open frame door.
